(19) United States
(12) Patent Application Publication
(10) Pub. No.: US 2011/0035315 A1
(43) Pub. Date: Feb. 10, 2011

(54) Methods and Apparatus for Directing Consumers to Debt Settlement Providers

(75) Inventor: Chris M. Langley, Port Jervis, NY (US)

Correspondence Address: LAW OFFICES OF MICHAEL L. WISE, LLC, 260 WALSH RD., LAGRANGEVILLE, NY, 12540, US

(73) Assignee: ENYFCU HOLDINGS, LLC, Ferndale, NY (US)

(21) Appl. No.: 12/536,588

(22) Filed: Aug. 6, 2009

(51) Int. Cl. G06Q 40/00

(52) U.S. Cl. 705/38; 705/35

(57) ABSTRACT

A consumer having a delinquent loan is directed to a debt settlement provider by a data processing system comprising a data processor in signal communication with a memory. Initially, the data processing system obtains a credit report for the consumer reflecting at least a portion of the consumer's credit history. The data processing system then determines the delinquent loan of the consumer directly from this credit report. Finally, the data processing system transmits information about the consumer and the delinquent loan to the debt settlement provider.

### FIELD OF THE INVENTION

The present invention relates generally to methods and apparatus for providing financial services, and, more particularly, to data processing systems and methods to be performed on data processing systems for directing consumers with delinquent loans to debt settlement providers.

### BACKGROUND OF THE INVENTION

Debt settlement, also known as “debt arbitration” or “debt negotiation,” is a process in which a debtor makes an agreement with a creditor to pay off a debt at an amount less than the outstanding balance. Typically, a debtor only qualifies for debt settlement when the creditor is convinced that the debtor is experiencing some kind of financial hardship that prevents the debtor from being able to fully repay their debts. Debt settlement almost always involves debts that are unsecured, such as medical expenses, utility bills, and credit card debt. Debt secured by collateral, such as car loans or home mortgages, are generally not eligible for debt settlement because the debtor may pursue relief for non-payment by repossessing the collateral.

Debt settlement is frequently facilitated by a third party service provider, a debt settlement provider (DSP). Such providers will negotiate with a creditor on behalf of a debtor and develop a debt settlement program. In such a program, a debtor is usually directed to start depositing money in a settlement account in lieu of paying the creditor. Subsequently, once these deposited funds are judged sufficient, the DSP attempts to negotiate a settlement offer with the creditor. Depending on the circumstances, the debtor may only have to pay 35-60% of the existing balance.

The DSP, in turn, profits by charging a fee. The manner in which this fee is calculated varies. Some DSPs charge a percentage of the total settled debt as their fee, while others charge a percentage of the debt reduction they are able to negotiate. Even others charge a monthly fee. Accordingly, if a DSP is able to obtain a sufficient customer base, debt settlement may be very lucrative. For this reason, many DSPs desire to advertise their services. Nevertheless, such advertising is difficult to target at those consumers that may actually benefit from debt settlement services, and is also typically very expensive. The return-on-investment from such advertising is, therefore, often unsatisfactory.

There is, as a result, a need for methods and apparatus that detect consumers that might benefit from debt settlement services, educate those consumers about the benefits of debt settlement in a compelling manner, and direct those consumers to DSPs that may be able to serve them.

### SUMMARY OF THE INVENTION

Embodiments of the present invention address the above-identified need by providing methods and apparatus that detect consumers that may benefit from debt settlement services and refer those consumers to participating DSPs.

In accordance with an aspect of the invention, a consumer having a delinquent loan is directed to a DSP by a data processing system comprising a data processor in signal communication with a memory. Initially, the data processing system obtains a credit report for the consumer reflecting at least a portion of the consumer's credit history. The data processing system then determines the delinquent loan of the consumer directly from this credit report. Finally, the data processing system transmits information about the consumer and the delinquent loan to the debt settlement provider.

In accordance with one of the above-described embodiments of the invention, a debt settlement referral system (DSRS) comprises a data processing system operative to communicate with a consumer over the Internet. In response to a request from the consumer, the DSRS obtains a credit report for the consumer and determines any delinquent loans directly from the credit report. The DSRS then presents the consumer with their credit report as well as with a debt settlement referral offer. The debt settlement referral offer summarizes the consumer's delinquent loans, provides a proposed settlement amount, and offers the consumer an opportunity to have the DSRS forward information about the consumer and the consumer's loans to a DSP.

Advantageously, the above-described embodiment allows the consumer to conveniently learn about debt settlement services and to be easily put in contact with a participating DSP. The DSP, in turn, receives a lead on a consumer who is in a financial situation that lends itself to debt settlement and who is potentially interested in receiving debt settlement services.

### BRIEF DESCRIPTION OF THE DRAWINGS

These and other features, aspects, and advantages of the present invention will become better understood with regard to the following description, appended claims, and accompanying drawings where:

FIG. 1 shows block diagram of a DSRS and various external elements in accordance with an illustrative embodiment of the invention;

FIG. 2 shows a flow chart of the configuration portion of an illustrative method embodiment for providing debt settlement referral services to a consumer;

FIG. 3 shows an illustrative set of debt settlement parameters;

FIG. 4 shows a flow chart of the debt settlement referral portion of the illustrative method embodiment for providing debt settlement referral services to a consumer;

FIG. 5 shows an illustrative web page that requests indentifying information from the consumer;

FIG. 6 shows an illustrative credit report; and

FIG. 7 shows an illustrative web page that provides the consumer with a credit report and debt settlement referral offer.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

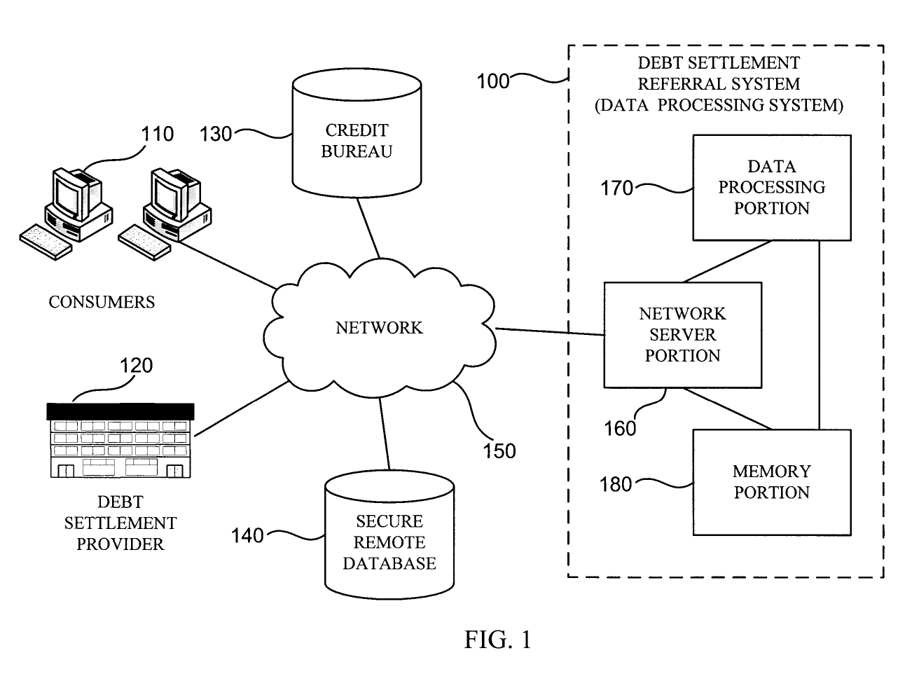

FIG. 1 shows a debt settlement referral system (DSRS) 100 for providing financial services in accordance with an illustrative embodiment of the invention. The illustrative DSRS is connected to several external elements, namely a plurality of consumers 110, a DSP 120, a credit bureau 130, and a secure remote database 140 via a network 150. The DSRS itself comprises a network server portion 160, a data processing portion 170, and a memory portion 180. These three portions combine to form a data processing system, and each portion performs a particular function within the DSRS. More specifically, the network server portion is operative to receive and transmit data over the network between the DSRS and the external elements. The data processing portion comprises a data processor and is operative to perform the logical steps and computations associated with the debt analysis operations, and to generate analysis data. Finally, the memory portion is operative to store data associated with the debt analysis operations. The network, data processing, and memory portions may comprise, for example, AS/400®, iSeries , or i5® servers available from International Business Machines Corporation (Armonk, N.Y., USA), or any analogous server-type computers.

It should be noted that the three portions 160, 170, 180 forming the DSRS 100 may, in fact, be implemented in a single computer or implemented in several linked computers. Their presentation as three separate elements in FIG. 1 is merely to draw attention to their functionality rather than to present their physical form. Once their novel functionality is understood, the programming of the computer or computers to implement the functionality will be well within the ability of one of ordinary skill in the art.

The network 150 preferably comprises the Internet (i.e., World Wide Web), allowing the consumers 110 to access the DSRS 100 using any internet-capable computer with a web browser program, such as a personal computer, cellular telephone, or personal digital assistant. This allows the DSRS to present its debt referral content to consumers in the form of information on web pages (i.e., this allows the DSRS to act as a web server that sends data formatted for presentment on web browser programs). Accordingly, computer-to-computer communications between the DSRS and the consumers is preferably performed using the Hypertext Transfer Protocol (HTTP), the Secure Sockets Layer (SSL) Protocol, or some combination thereof. For communication between the DSRS and the other external elements 120, 130, 140, the Internet may also be utilized or a more private network connection may be chosen. Alternative network connections may include, as just a few examples, point-to-point (leased line), circuit switched, or packet switched Wide Area Networks (WANs).

As will be described in greater detail below, the DSP 120 voluntarily enrolls with the DSRS 100 to become a “participating” DSP in order to gain exposure to consumers 110 that may be interested in acquiring debt settlement services. For ease of understanding, only a single participating DSP is shown in FIG. 1, but it is possible that several different DSPs may be enrolled with the DSRS at any given time.

Lastly, the credit bureau 130 comprises one or more databases that store credit history data for the consumers 110. The databases may, for example, be populated with consumer credit history data collected by one or more of the three largest credit bureaus, namely Experian® (West Orange, Calif., USA), TransUnion® (Chicago, Ill., USA), and Equifax® (Atlanta, Ga., USA). The secure remote database 140, on the other hand, is a database external to the DSRS 100 that, in the present illustrative embodiment, is primarily tasked with storing sensitive financial information about the consumers. Such sensitive information may include, for example, the data gleaned from the consumers' credit reports. Safeguards such as data encryption and other methodologies known in the art are preferably utilized to protect data stored in the secure remote database. The secure and remote nature of the secure remote database is utilized in response to governmental regulatory requirements and consumer expectations for securing this kind of sensitive personal information.

The function of the different elements in FIG. 1 will now be described with reference to an illustrative “direct-to-consumer” method embodiment for providing debt settlement referral services to consumers in accordance with aspects of the invention. For ease of understanding, the illustrative method can be broken up into two portions: a configuration portion, and a debt settlement referral portion.

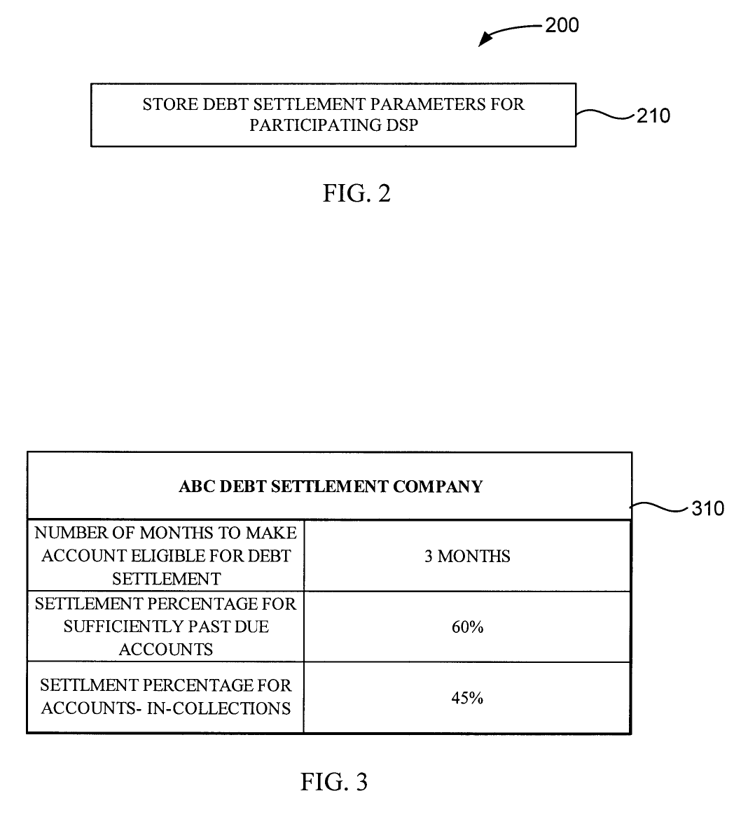

FIG. 2 shows a flow chart of the configuration portion 200 of the illustrative method embodiment wherein the DSRS 100 receives and stores data from the participating DSP 120 for later use in servicing the consumers 110. In step 210, the DSRS receives and stores a set of debt settlement parameters for the DSP. In the present embodiment, the debt settlement parameters comprise three parameters, namely: 1) the number of months required to cause an account that is not already in collections to be sufficiently past due to qualify for debt settlement; 2) the settlement percentage for such “sufficiently past due accounts”; and 3) the debt settlement percentage for accounts already in collections (“accounts-in collections”). As used herein, the term “debt settlement percentage” indicates the percentage of the outstanding debt balance that the DSP will offer to pay a creditor on behalf of a debtor in order to extinguish that debtor's debt with the creditor. For example, FIG. 3 shows a set of debt settlement parameters 310 for an exemplary DSP, “ABC Debt Settlement Company,” presented in the form of a table. These debt settlement parameters indicate that ABC Debt Settlement Company will attempt to settle an unsecured loan that is more than 3 months past due, but not yet in collections, for an amount equal to 60% of the outstanding balance. ABC Debt Settlement Company will attempt to settle an unsecured loan presently in collections for 45% of the outstanding balance.

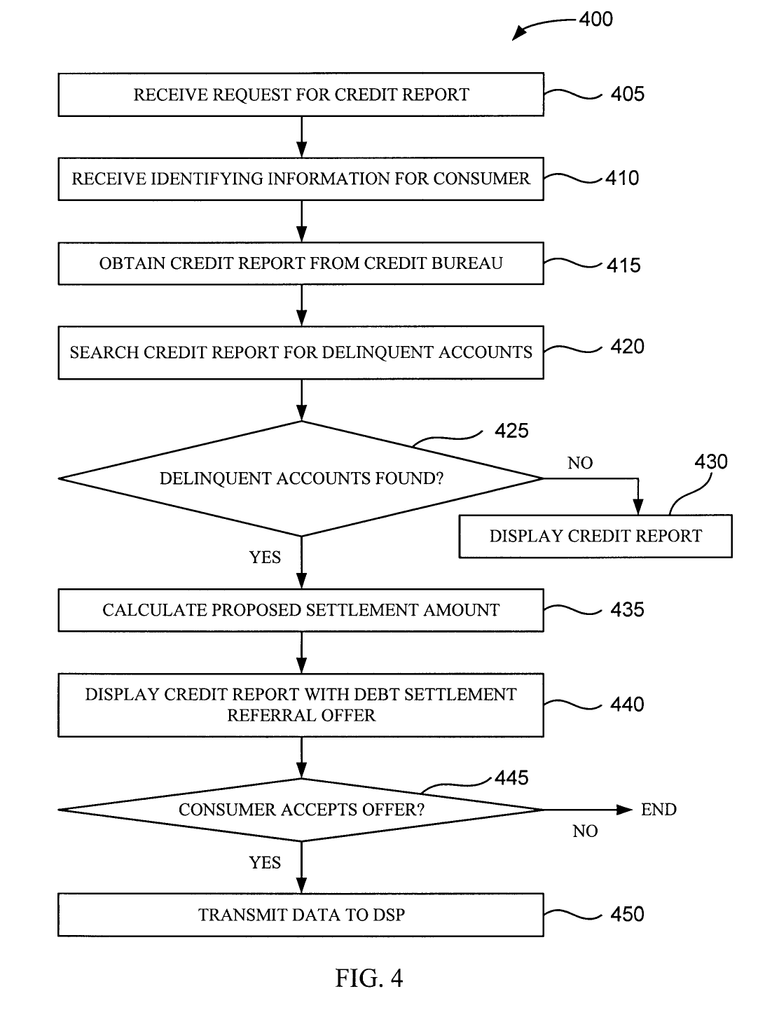

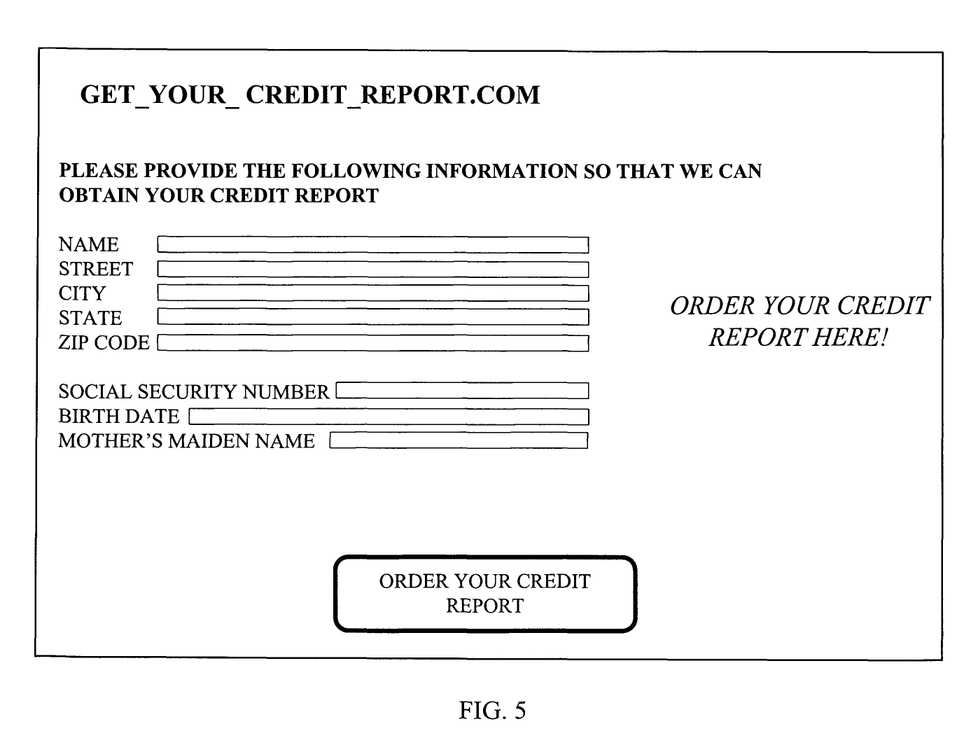

FIG. 4 goes on to show the debt settlement referral portion 400 of the illustrative method embodiment. This portion is performed after a consumer 110 accesses the web site of the DSRS 100. In step 405, the DSRS offers to provide the consumer with the consumer's credit report. Many consumers will periodically order their credit reports in order to determine the status of their existing debts, their credit scores, whether the reports contain any errors, and whether there are any indications of identity fraud. If the consumer indicates that the consumer desires to receive the credit report, the DSRS moves on to step 410 and the DSRS obtains identifying information from the consumer. This may be performed by querying the consumer for the consumer's name, address, social security number, birth date, mother's maiden name, and other such identifying information. FIG. 5 shows an illustrative web page that might be presented to the consumer during step 410. Once this identifying information is received, the DSRS advances to step 415 and utilizes the information obtained in the previous step to obtain the consumer's credit report from the credit bureau 130.

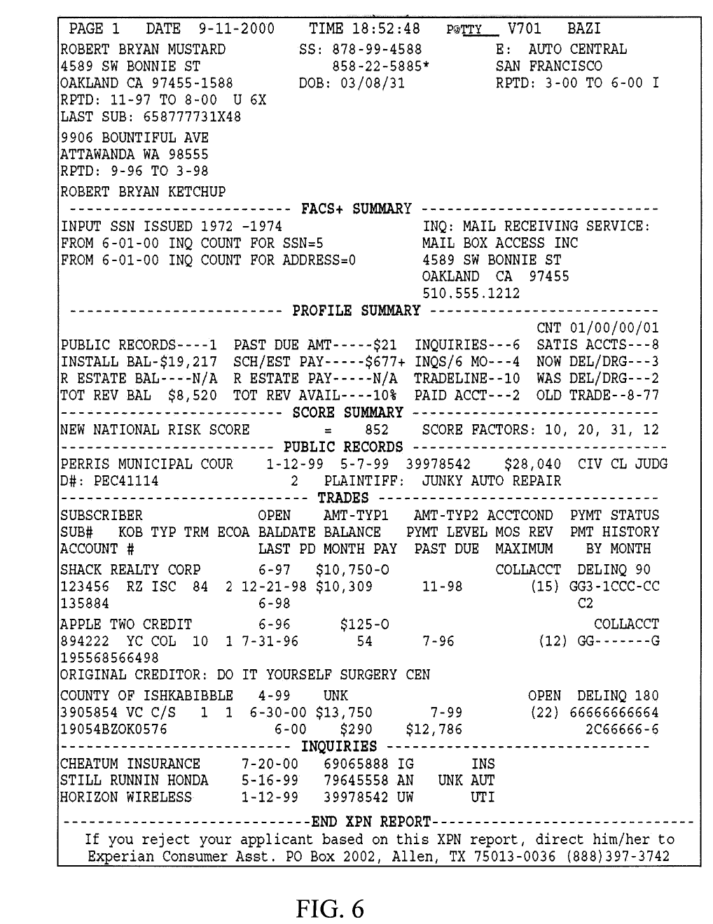

FIG. 6, in turn, shows what the credit report obtained in step 415 might look like. This particular credit report is in a text format that is typical of credit reports generated by Experian. Credit reports provided by other credit bureaus may be formatted somewhat differently, but typically include similar information. The report has several elements and codes that will be familiar to one skilled in the art and that are readily understood by reference to descriptive materials available from the credit bureaus and elsewhere. Briefly, in addition to personal data such as name and address, the report describes the consumer's public records on bankruptcies, liens, and civil law suits. In addition, the consumer's loan history, including existing and past loans, is presented in what are normally called “tradelines” or “trades.” The credit report may also present information on “hard” inquiries made by third parties (e.g., lenders) to the credit bureau, as well as the consumer's credit score.

As can be seen in the credit report sample shown in FIG. 6, the tradelines (trades) provide detailed parameters for each of the consumer's existing loans. The tradelines, for example, include the loan type, original balance, term, opening date, monthly payment, and last payment. In addition, the tradelines also provide a Payment History Section (far right on FIG. 6) which utilizes a series of numerical and letter codes to indicate the monthly status of the account over the past several months. In the present report, for example, a “C” in the Payment History Section indicates that the account was current on that month, while a numeral between “1” and “6” indicates that the account was past due by that number of months, and a “G” indicates that the account was in collections. The present report further provides a Payment Status Indicator (also far right on FIG. 6). Here a “DELINQ 90” notation indicates that the account is presently 90 days past due, a “DELINQ 180” notation indicates that the account is presently 180 days past due, and a “COLLACCT” notation indicates the account is presently already in collections.

Next, in step 420 of FIG. 4, the DSRS 100 searches the credit report for sufficiently past due accounts and accounts-in-collections (hereinafter, collectively called “delinquent accounts”). In accordance with aspects of the invention, it does so solely by reference to the credit report obtained in step 415. More specifically, the DSRS parses the data presented in the credit report's tradelines to determine any existing loans that are past due by the number of months required to define a loan as sufficiently past due (as indicated in the debt settlement parameters 310) as well as any existing loans that are already in collections. If the credit report is similar to that shown in FIG. 6, for example, the DSRS may determine the delinquent accounts by examining the information provided in one or both of the credit report's Payment History and Payment Status Indicator sections, as indicated above.

The actual parsing of the credit report to determine any delinquent accounts in step 420 is performed by conventional data processing methods that will be familiar to one of ordinary skill in the art. Although not the only method coming within the scope of this invention, the credit report data may be, for example, initially converted into an Extensible Mark-up Language (XML) format in conformity with specifications provided by the Mortgage Banker's Association of America Mortgage Industry Standards Maintenance Organization (MISMO). In this manner, credit report data provided by different credit bureaus is normalized and provided with standardized XML descriptors and wordings. Commercial software, such as the MERit Credit Engine from Merit Credit Systems, Inc. (Montrose, Calif., USA), is available to perform this kind of processing on credit report data. Once so formatted, the DSRS 100 can easily cycle through the XML data and extract the desired account information. The XML format is also a convenient format for storing the credit report data for later use. In the present example, the data may be stored in the secure remote database 140.

In step 425, the method 400 branches based on the results of step 420. If the DSRS 100 did not find any delinquent accounts, the system advances to step 430, wherein it presents the credit report to the consumer as requested by the consumer in step 405. If, instead, the DSRS did find one or more delinquent accounts, it advances to step 435 and begins the process of preparing an offer to the consumer for referral to the DSP 120 (i.e., it begins to prepare a “debt settlement referral offer”).

Preparation of the debt settlement referral offer begins in step 435, wherein the DSRS 100 calculates the proposed debt settlement amount. The proposed debt settlement amount, PDSA, is simply:

PDSA=(B_{SPDA}×SP_{SPDA})+(B_{AIC}×SP_{AIC}),

where B_{SPDA} is the balance due on any sufficiently past due accounts, SP_{SPDA} is the settlement percentage for sufficiently past due accounts, B_{AIC} is the balance due on any accounts-in-collections, and SP_{AIC} is the settlement percentage for accounts-in-collections. Both SP_{SPDA} and SP_{AIC} can be determined from the debt settlement parameters 310. If, for example, the consumer 110 has sufficiently past due accounts with a combined outstanding balance of $6,123, and has accounts-in-collections with a combined outstanding balance of $4,111, then the proposed debt settlement amount would be calculated to be $5,224 based on the settlement percentages provided in the exemplary debt settlement parameters shown in FIG. 3.

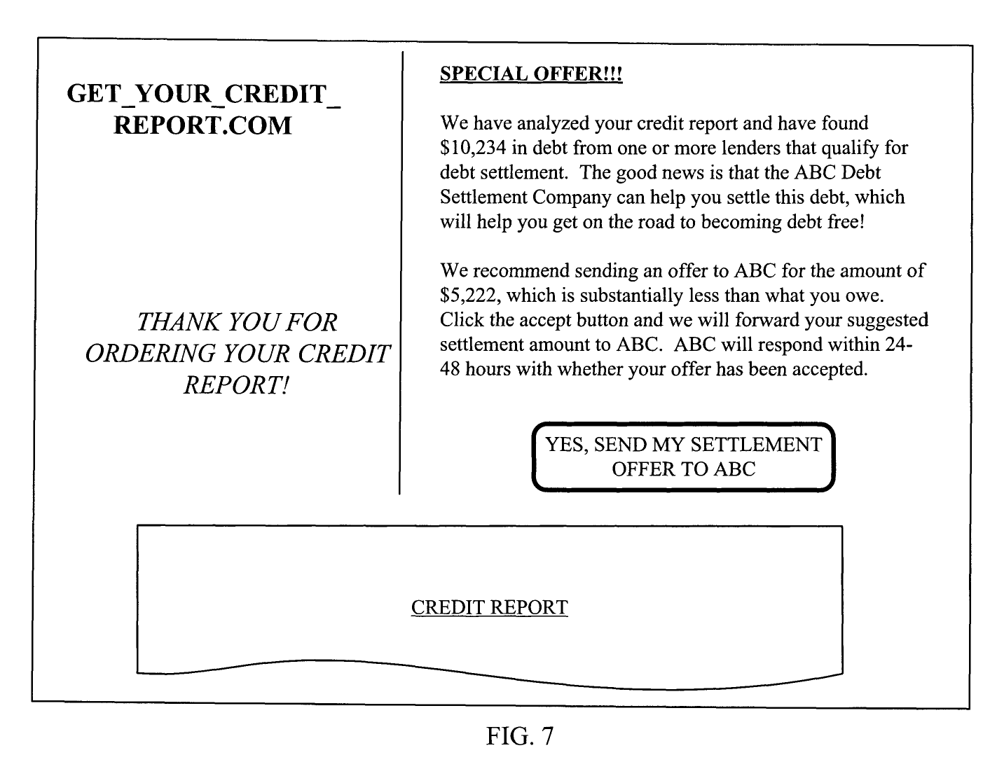

In step 440, the DSRS 100 then presents the consumer 110 with the consumer's credit report in combination with the debt settlement referral offer. FIG. 7 shows an illustrative example of such a combined presentation, which is displayed for the consumer in the form of a web page (debt settlement referral offer in upper right). The debt settlement referral offer summarizes the total outstanding balance for delinquent accounts found in step 420, and also provides the consumer with the proposed debt settlement amount calculated in step 435. Lastly, the debt settlement referral offer provides the consumer with a button which allows the consumer to select whether that consumer wants to contact the DSP 120 regarding debt settlement services.

In addition, and optionally, the debt settlement referral offer may also provide the consumer 110 with an estimate of the manner in which that consumer's credit score may be improved by settling the delinquent accounts using the services of the DSP 120.

Next, as indicated in step 445, the illustrative method 400 ends if the consumer 110 chooses not to accept the debt settlement referral offer. If, on the other hand, the consumer accepts the offer, the DSRS 100 advances to step 450. Here, the DSRS forwards the consumer's relevant information to the DSP 120 including the consumer's identifying information, credit report, delinquent accounts, and proposed debt settlement amount. The DSP is then able to contact the consumer directly and pursue a business relationship with the consumer if the DSP so desires.

In this manner, the illustrative debt settlement referral method 400 allows the consumer 110 to conveniently learn about debt settlement services that may help that consumer substantially improve the consumer's financial situation. Such information may be very compelling to the consumer because the consumer is reminded about that consumer's present debt situation and also learns that the consumer may only have to pay a fraction of the consumer's outstanding debts to extinguish those debts. In addition, the DSRS 100 allows the consumer to be put in contact with the DSP 120 merely by selecting a single button on a web page. The DSP, in turn, receives a lead on a consumer who is in a financial situation that lends itself to debt settlement and is potentially interested in pursuing debt settlement negotiations with that consumer's creditors. The DSP is then free to pursue that lead directly with the consumer in order to provide those services.

It should again be emphasized that the above-described embodiments of the invention are intended to be illustrative only. Other embodiments can use additional or different types and configurations of elements and process steps for implementing the described functionality. These numerous alternative embodiments within the scope of the appended claims will be apparent to one skilled in the art.

Moreover, all the features disclosed herein may be replaced by alternative features serving the same, equivalent, or similar purpose, unless expressly stated otherwise. Thus, unless expressly stated otherwise, each feature disclosed is one example only of a generic series of equivalent or similar features.

1. A method of directing a consumer having a delinquent loan to a debt settlement provider, the method to be performed by a data processing system comprising a data processor in signal communication with a memory, the method comprising the steps of:
obtaining a credit report for the consumer reflecting at least a portion of the consumer's credit history;
determining the delinquent loan of the consumer directly from the credit report; and
transmitting information about the consumer and the delinquent loan to the debt settlement provider.

2. The method of claim 1, further comprising the step of providing the credit report to the consumer.

3. The method of claim 2, wherein the providing step comprises transmitting data formatted for presentment by a web browser.

4. The method of claim 1, wherein the obtaining step comprises obtaining the credit report from a credit bureau.

5. The method of claim 1, wherein the determining step comprises parsing contents of one or more tradelines in the credit report.

6. The method of claim 1, wherein the determining step comprises converting at least a portion of the credit report to a format in accordance with the Extensible Mark-up Language.

7. The method of claim 1, further comprising the step of offering the consumer a choice whether to transmit information about the consumer and the delinquent loan to the debt settlement provider.

8. The method of claim 7, wherein the offering step comprises providing the consumer with an amount of the delinquent loan.

9. The method of claim 7, wherein the offering step comprises providing the consumer with a proposed settlement amount for the delinquent loan.

10. The method of claim 1, further comprising the step of receiving a request from the consumer to provide the credit report.

11. The method of claim 1, further comprising the step of providing the consumer with an estimate of a change to a credit score of the consumer that may result from the consumer settling the delinquent loan.

12. A data processing system operative to direct a consumer having a delinquent loan to a debt settlement provider, the data processing system comprising:
a memory portion; and
a data processor portion in signal communication with the memory portion, the data processor portion operative to obtain a credit report for the consumer reflecting at least a portion of the consumer's credit history, determine the delinquent loan of the consumer directly from the credit report, and transmit information about the consumer and the delinquent loan to the debt settlement provider.

13. The data processing system of claim 12, wherein the data processor portion is operative to act as a web server.

14. The data processing system of claim 12, wherein the data processor portion is operative to transmit data formatted for presentment by a web browser.

15. The data processing system of claim 12, wherein the data processor portion is operative to parse one or more tradelines in the credit report.

16. The data processing system of claim 12, wherein the data processor portion is operative to provide the consumer with an amount of the delinquent loan.

17. The data processing system of claim 12, wherein the data processor portion is operative to provide the consumer with a proposed settlement amount for the delinquent loan.

18. Computer instructions embodied on one or more computer-usable media for directing a consumer having a delinquent loan to a debt settlement provider, the computer instructions, when executed by a computer having a data processor in signal communication with a memory, operative to cause the computer to perform the steps of:
obtaining a credit report for the consumer reflecting at least a portion of the consumer's credit history;
determining the delinquent loan of the consumer directly from the credit report; and
transmitting information about the consumer and the delinquent loan to the debt settlement provider.
